(19) United States
(12) Patent Application Publication
(10) Pub. No.: US 2011/0129597 A1
(43) Pub. Date: Jun. 2, 2011

(54) ANTIBACTERIAL ELECTRONIC DEVICE AND METHOD FOR MANUFACTURING THE SAME

(75) Inventor: Chih-Hao HUANG, Taipei Hsien (TW)

(73) Assignee: CHENG UEI PRECISION INDUSTRY CO., LTD., Taipei Hsien (TW)

(21) Appl. No.: 13/024,616

(22) Filed: Feb. 10, 2011

Related U.S. Application Data
(62) Division of application No. 12/050,923, filed on Mar. 18, 2008.

(51) Int. Cl. B05D 5/00; B05D 3/02

(52) U.S. Cl. 427/125; 427/58; 427/126.3

(57) ABSTRACT

The present invention relates to a method for manufacturing an antibacterial electronic device. The method includes the steps of: (1) dispersing antibacterial material into alcohol solution with a predetermined concentration to form an even mixture solution; (2) laying statically the even mixture solution for a predetermined period of time to obtain a uniform and steady antibacterial solution; (3) coating the antibacterial solution to a surface of an insulating shell of an electronic device, the surface of the insulating shell of the electronic device with the antibacterial solution being dried at a temperature ranging from 50-150 degrees centigrade for obtaining a continuous antibacterial layer tightly attached to the surface of the insulating shell.

### CROSS-REFERENCE TO RELATED APPLICATIONS

This application is a Divisional of the pending U.S. patent application Ser. No. 12/050,923 filed on Mar. 18, 2008, all of which is hereby incorporated by reference in its entirety.

Although incorporated by reference in its entirety, no arguments or disclaimers made in the parent application apply to this divisional application. Any disclaimer that may have occurred during the prosecution of the above-referenced application(s) is hereby expressly rescinded. Consequently, the Patent Office is asked to review the new set of claims in view of the entire prior art of record and any search that the Office deems appropriate.

### BACKGROUND OF THE INVENTION

1. Field of the Invention

The present invention relates to an antibacterial electronic device, and more particularly to a method for manufacturing the antibacterial electronic device.

2. The Related Art

According to recent improvement in economic status and resulting interest in well-being, various products which contact the human body during use tend to need antibacterial properties, such as mobile phone, earphone, PDA and so on. These portable electronic devices carried on the users' hands are easy to breed bacteria on the surface thereof, which may infect the users' body via the mouth.

To prevent the bacteria from breeding, there are some methods adopted to manufacture the electronic devices with the antibacterial properties. At present, the electronic devices with the antibacterial properties are mainly manufactured via putting the antibacterial material into the material of the shell of the electronic device directly.

However, the conventional method putting the antibacterial material into the material of the shell directly tends to destroy the original properties of the material of the shell of the electronic device and reduce the antibacterial effect of the antibacterial material. Furthermore, some electronic devices only require the antibacterial properties on the surface thereof. So the conventional method wastes the antibacterial material because of plenty of antibacterial material injected into the material of the shell for achieving the predetermined antibacterial effect. So a method which can keep original properties of the material of the shell and meet antibacterial demand with a less amount of antibacterial material is required.

### SUMMARY OF THE INVENTION

Accordingly, an object of the present invention is to provide a method for manufacturing an antibacterial electronic device with an insulating shell, which not only keeps original properties of the material of the insulating shell and the antibacterial material, and reduces a using amount of the antibacterial material, but also can form a continuous antibacterial layer on the surface of the electronic device to improve the antibacterial effect.

A method for manufacturing an antibacterial electronic device with an insulating shell including the steps of:
a. preparing antibacterial solution: dispersing antibacterial material into alcohol solution with a predetermined concentration to form an even mixture solution, the even mixture solution being laid statically for a predetermined period of time to obtain a uniform and steady antibacterial solution;
b. coating a surface of an insulating shell of an electronic device with the antibacterial solution; and
c. drying the surface of the insulating shell of the electronic device with the antibacterial solution at a temperature ranging from 50-150 degrees centigrade for obtaining a continuous antibacterial layer tightly attaching to the surface of the insulating shell.

Another object of the present invention is to provide an antibacterial electronic device including an insulating shell having a surface with a plurality of small holes therein and an continuous antibacterial layer coated on the surface of the insulating shell and filling the smaller holes of the insulating shell.

As described above, the method for manufacturing an antibacterial electronic device with an insulating shell can keep original properties of the material of the insulating shell and the antibacterial material, and save the using amount of the antibacterial material. Furthermore, the antibacterial electronic device has stronger sterilization function than the prior art because of the antibacterial material applied directly to the surface of the insulating shell of the electronic device and forming a continuous antibacterial layer.

### BRIEF DESCRIPTION OF THE DRAWINGS

The present invention will be apparent to those skilled in the art by reading the following description of a preferred embodiment thereof, with reference to the attached drawings, in which:

FIG. 1 is a partial cross-sectional view of an insulating shell of an electronic device; and

FIG. 2 is a partial cross-sectional view showing an antibacterial layer formed on a surface of the insulating shell shown in FIG. 1 according to an embodiment of the present invention.

### DETAILED DESCRIPTION OF THE PREFERRED EMBODIMENTS

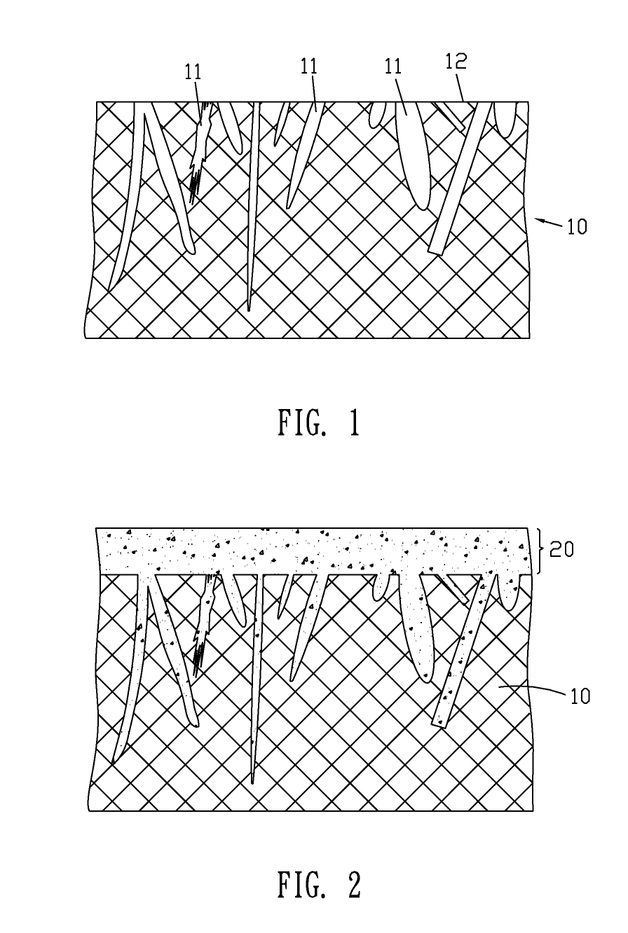

With reference to FIG. 1 and FIG. 2, an antibacterial electronic device includes an insulating shell 10. The insulating shell 10 defines an outer surface 12 and a plurality of small holes 11 defined in the outer surface 12. The outer surface 12 of the insulating shell 10 is coated with an antibacterial layer 20 formed by nano antibacterial material. Furthermore, parts of the antibacterial layer 20 penetrate into the small holes 11 to make the antibacterial layer 20 formed continuously on the outer surface 12.

A method for making the antibacterial electronic device includes the steps of:
1. Preparing antibacterial solution: the nano antibacterial material and the alcohol solution are mixed together with a predetermined concentration and agitated for dispersing the nano antibacterial material into the alcohol solution fully to form an even mixture solution. The even mixture solution is laid statically over 24 hours for obtaining a uniform and steady antibacterial solution. Wherein the nano antibacterial material is either one of the nano photocatalysis titanium dioxide and the nano silver or both of the nano photocatalysis titanium dioxide and the nano silver. The alcohol solution is either one of the ethanol and the isopropanol or both of the ethanol and the isopropanol. When both of the nano photocatalysis titanium dioxide and the nano silver are used as the nano antibacterial material, the weight of the nano photocatalysis titanium dioxide is preferrablely equal to that of the nano silver for obtaining better antibacterial effect. The rate of the nano antibacterial material mixed with the alcohol solution is shown in the following table.

| Sample | Nano Photocatalysis | Nano | | |
|---|---|---|---|---|
| NO. | Titanium Dioxide | sliver | Ethanol | Isopropanol |
| 1 | 10 | 0 | 90 | 0 |
| 2 | 20 | 0 | 80 | 0 |
| 3 | 40 | 0 | 0 | 60 |
| 4 | 15 | 0 | 85 | 0 |
| 5 | 18 | 0 | 82 | 0 |
| 6 | 30 | 0 | 0 | 70 |
| 7 | 2.5 | 2.5 | 0 | 95 |
| 8 | 10 | 10 | 80 | 0 |
| 9 | 20 | 20 | 0 | 60 |
| 10 | 18 | 15 | 32 | 35 |

2. Coating: the outer surface 12 of the insulating shell 10 of the electronic device is coated with the antibacterial solution via injecting, brushing and so on, the small holes 11 of the insulating shell 10 is filled by the nano antibacterial material, thus the antibacterial layer 20 is continuously formed on the surface 12.
3. Drying: the outer surface 12 of the insulating shell 10 of the electronic device with the antibacterial solution is performed to dry at a temperature ranging from 50-150 degrees centigrade. With the alcohol solution volatilizing, the nano antibacterial material gradually adheres to the outer surface 12 of the insulating shell 10. When the alcohol solution volatilizes completely, the nano antibacterial material forms a continuous antibacterial layer 20 tightly attached to the outer surface 12 of the insulating shell 10.

As described above, the method for manufacturing the antibacterial electronic device not only keeps original properties of the material of the insulating shell 10 and the nano antibacterial material, but also saves the using amount of the nano antibacterial material. Furthermore, the nano antibacterial material is injected into the small holes 11 of the insulating shell 10 and then forms a continuous antibacterial layer 20 on the outer surface 12 of the insulating shell 10, which effectively prevents the bacterial from parasitizing in the small holes 11 of the insulating shell 10 and strengthens the antibacterial effect of the outer surface 12 of the insulating shell 10 because of the nano antibacterial material formed thereon directly.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A method for manufacturing an antibacterial electronic device with an insulating shell comprising the steps of:
a. dispersing antibacterial material into alcohol solution with a predetermined concentration to form an even mixture solution, the even mixture solution being laid statically for a predetermined period of time to obtain a uniform and steady antibacterial solution;
b. coating a surface of the insulating shell of the electronic device with the antibacterial solution; and
c. drying the surface of the insulating shell of the electronic device at a temperature ranging from 50-150 degrees centigrade to form a continuous antibacterial layer tightly attached to the surface of the insulating shell.

2. The method as claimed in claim 1, wherein the antibacterial material is nano photocatalysis titanium dioxide added in an amount of from 10 to 40 weight %, based on the total weight of the antibacterial solution.

3. The method as claimed in claim 1, wherein the antibacterial material is nano silver added in an amount of from 5 to 30 weight %, based on the total weight of the antibacterial solution.

4. The method as claimed in claim 1, wherein the antibacterial material is a mixture of nano photocatalysis titanium dioxide and nano silver, the nano photocatalysis titanium dioxide and the nano silver have the same weight and are added in an amount of from 2.5 to 20 weight % respectively, based on the total weight of the antibacterial solution.

5. The method as claimed in claim 1, wherein the alcohol solution is ethanol.

6. The method as claimed in claim 1, wherein the alcohol solution is isopropanol.

7. The method as claimed in claim 1, wherein the alcohol solution is a mixture of ethanol and isopropanol.
